(19) United States
(12) Patent Application Publication
(10) Pub. No.: US 2017/0108167 A1
(43) Pub. Date: Apr. 20, 2017

(54) CLAMPING DEVICE WITH AUXILIARY FUNCTIONS

(71) Applicant: Eagle Fan, Chu-Pei (TW)

(72) Inventor: Eagle Fan, Chu-Pei (TW)

(21) Appl. No.: 14/883,656

(22) Filed: Oct. 15, 2015

(51) Int. Cl. F16M 13/04; G03B 17/56; F16M 13/06

(52) U.S. Cl. CPC F16M 13/04; F16M 13/06; G03B 17/561

(57) ABSTRACT

A clamping device includes a pivot seat; a clamp seat for clamping an object thereon and formed a hook member, and having a lower portion connected pivotally to the pivot seat; and a telescopic structure disposed behind the clamp seat. The telescopic structure defines a hollow space corresponding to the hook member of the clamp seat, and includes two retractable rod units. Each retractable rod unit includes a first retractable rod having a first end connected pivotally to the pivot seat and a second retractable rod connected movably to the first retractable rod such that the second retractable rod is movable relative to the first retractable rod between a retractable position, in which, the first retractable rod is accommodated within the second retractable rod and an extended position, in which, the first retractable rod is exposed at least partially to an exterior of the second retractable rod.

### BACKGROUND OF THE INVENTION

1. Field of the Invention

The present invention relates generally to a clamping device, and more particularly to a clamping device with auxiliary functions so that the clamping device is capable of clamping an electronic device, like a smart phone, and capable of providing auxiliary functions, like serving as a phone photo-taking selfie.

2. The Prior Arts

Using a smart phone, a tablet computer, a navigation device, taking photo with the smart phones, surfing the Internet, watching movies, and vehicle navigation over the smart phones are common jobs done by majority of people nowadays. Regarding this matter, there are a lot of related assistive tools, such as a phone photo-taking selfie, a tripod or a hanging device that has a clamping device for clamping a smart phone and together with other assistant instruments to facilitate in taking one's own photo with the smart phone. For instance, a conventional phone photo-taking selfie includes a clamping member and a retractable rod unit mounted at a rear side surface of the clamping member in order to adjust the distance between the smart phone and the phone user so as to facilitate in taking one's own photograph. The conventional phone photo-taking selfie further includes a base member that is fixed at a bottom of the clamping member and that holds the smart phone at a horizontal position such that the user can easily surf the Internet or watch a movie in the display panel of the smart phone, thereby eliminating the problem of holding the smart phone by a user hand. The hanging device generally includes an engagement groove. A hook connected to a suction cup inserts into the engagement groove and the suction cup is adapted to be press-fitted onto a windscreen of a car so that the driver can hang his smart phone on the hanging device once the smart phone is switched to a navigation mode for providing guiding information or the traveling route.

It is noted that the majority of presently available assistive tools each provides a single function only. In other words, each assistive tool fails to provide multiple functions, like taking one's own photo, supporting the smart phone at a desired angle to facilitate watching by the user or sticking the smart phone on a windscreen of a car for serving as navigation system.

To be more specific, the conventional phone photo-taking selfie includes a single retractable rod such that the retractable rod can not hold the smart phone at a horizontal position. In addition, the retractable rod is mounted at a rear side surface of the clamping member and in case the rear side surface thereof is formed with an engagement groove, the retractable rod may cover the engagement groove and may prevent mounting of the suction cup in the groove such that the smart phone cannot be fixed on the suction cup.

In the event that the retractable rod is mounted to the base member, the former fails to provide the supporting function. Moreover, if an engagement groove is formed on the rear side surface of the clamping member, a fixed angle will be formed between the base member and the clamping member owing to integrally formation between the two, in which, the base member prevents attachment of the hook and the suction cup with respect to the engagement groove. Under this condition, the suction cup cannot be press-fitted onto the windscreen of a car.

Whether a retractable rod is disposed at the rear side surface of the clamping member or a base member is attached to a lower portion of the clamping member, said retractable rod or said base member prevents attachment of the hook and the suction cup with respect to the engagement groove, which in turn, causes the suction cup unable to be press-fitted onto the windscreen of a car.

### SUMMARY OF THE INVENTION

A primary objective of the present invention is to provide a clamping device having a telescopic structure provided with auxiliary functions, such as support and retractable-extending features so as not to interfere with the hanging member fixed to a suction cup and the hook member of a clamp seat, thereby facilitating the user in taking a photo by himself.

A clamping device with auxiliary functions of the present invention according includes a pivot seat, a clamp seat and a telescopic structure.

The clamp seat is used for clamping an object thereon and is formed a hook member, and has a lower portion connected pivotally to the pivot seat.

The telescopic structure is disposed behind the clamp seat, defines a hollow space corresponding to the hook member of the clamp seat, and includes two retractable rod units. Each retractable rod unit includes a first retractable rod having a first end connected pivotally to the pivot seat and a second retractable rod connected movably to the first retractable rod such that the second retractable rod is movable relative to the first retractable rod between a retractable position, in which, the first retractable rods are accommodated within the second retractable rods and an extended position, in which, the first retractable rods are exposed at least partially to exteriors of the second retractable rods.

In one embodiment of the present invention, the clamp seat includes a primary plate, a clamping block, a back plate and a spring. The primary plate has a front side surface formed with two support stubs projecting frontward and a rear side surface formed with the lower portion and two pivot lugs projecting rearward for connecting pivotally to the pivot seat. The clamping block includes a movable plate disposed movably between the primary plate and the back plate and a clamping plate disposed atop the movable plate in such a manner to extend transversely, frontwardly beyond a top end of the primary plate. The back plate has a rear side surface formed with the hook member. The spring is disposed between the movable plate and the back plate, and has two opposite ends respectively connected to the movable plate and the back plate. Preferably, the rear side surface of the primary plate is formed with an insert hole. The back plate has a front side surface formed with an insert stick for extending into the insert hole in the primary plate. The movable plate has a rear side surface formed with a hook for engagement with one end of the spring while another end thereof is engaged to the insert stick of the back plate. To be more specific, the movable plate has a lower portion formed with an opening to permit extension of the insert stick of the back plate while the movable plate is disposed movably between the primary plate and the back plate. The clamp seat further includes four cushioning pads, one is disposed on the front side surface of the primary plate, two are disposed on the support stubs of the primary plate while one is disposed at a lower surface of the clamping plate in front of the movable plate.

According to the present invention, the hook member of the back plate is configured as an engagement channel. The engagement channel preferably includes a dented potion and an opening portion connected spatially to the dented portion and extending through the back plate. The opening portion has a dimension smaller than the dented portion such that the dented portion and the opening portion are configured as T-shape.

In one embodiment of the present invention, each of the two second retractable rods defines a first-rod reception channel such that when the second retractable rods are moved to the retractable position, the first retractable rods are accommodated within the first-rod reception channels in the second retractable rods and that when the second retractable rods are moved to the extended position, the first retractable rods are exposed at least partially to the exteriors of the second retractable rods. Each retractable rod unit further includes a third retractable rods connected telescopically to the first and second retractable rods. To be more specific, each of the two third retractable rods defines a second-rod reception channel such that when the second and third retractable rods are moved to the retractable position, the first retractable rods are accommodated within the second-rod reception channels in the third retractable rods while the third retractable rods are accommodated with the first-rod reception channels in the second retractable rods, and when the second and third retractable rods are moved to the extended position, the first retractable rods are exposed at least partially to the exteriors of the third retractable rods while the third retractable rods are exposed at least partially to the exteriors of the second retractable rods.

According to an embodiment of the present invention, the telescopic structure further includes a handgrip defining two parted rod-reception channels for receiving the two second retractable rods therein. Preferably, the handgrip includes a handgrip body formed with the two parted rod-reception channels and the hollow space, two covers respectively covering the two parted rod-reception channels and formed with two positioning holes, and two fasteners extending through two positioning holes in the two second retractable rods and the two positioning holes in the two covers, thereby fixing the two second retractable rods in the two parted rod-reception channels.

According to an embodiment of the present invention, the pivot seat includes a pivot body defining a horizontal through hole and two vertical holes for receiving the two first retractable rods therein, an axle extending rotatably through the horizontal through hole in the pivot body, and a rotary knob mounted detachably on one end of the axle. The lower portion of the clamp seat is connected pivotally to the axle such that rotation of the rotary knob relative to the pivot body results in tightening and loosening of the lower portion of the clamp seat relative to the pivot body. Preferably, the clamp seat is rotatable relative to the pivot seat within a range greater than 180°.

One distinct feature of the present invention resides in that the telescopic structure of the clamping device provides the support function in addition to the retractable-and-extendable function, and does not affect attachment of the hanging member of the suction cup relative to the hook member of the clamp seat, thereby facilitating in taking of photographs by himself, supporting the smart phone at a desired angle relative to the user or hanging of the smart phone on the windscreen of a car for serving as a navigation system.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a clamping device with auxiliary functions according to the present invention;

FIG. 2 is an exploded view of the clamping device with auxiliary functions according to the present invention;

FIG. 3 is an exploded view of the clamping device with auxiliary functions according to the present invention from another angle;

FIG. 4 shows the clamping device with auxiliary functions according to the present invention in application together with a suction device;

FIG. 5 shows the clamping device of the present invention holding a smart phone in a horizontal position;

FIG. 6 shows the clamping device with auxiliary functions according to the present invention serving a phone photo-taking selfie;

FIG. 7 is a partial exploded view of the clamping device with auxiliary functions according to the present invention; and

FIG. 8 is a cross-sectional and lateral side view of the clamping device of the present invention taken along lines A-A in FIG. 1.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

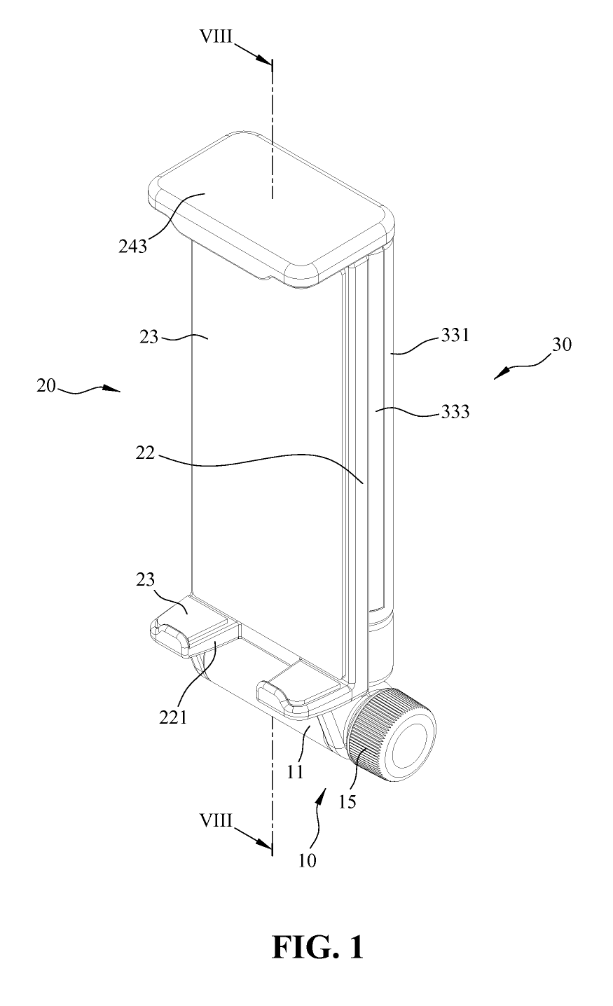

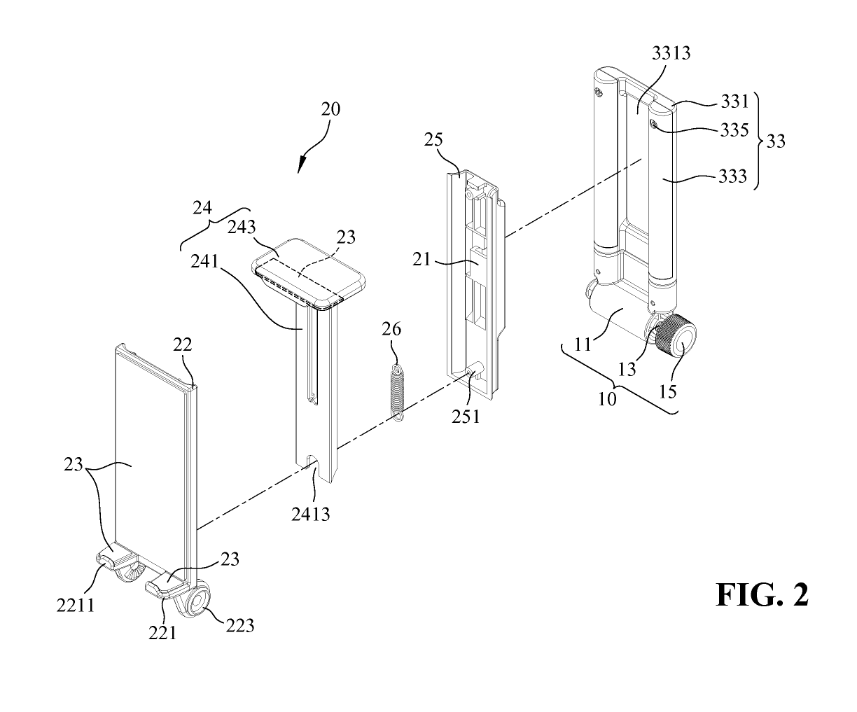

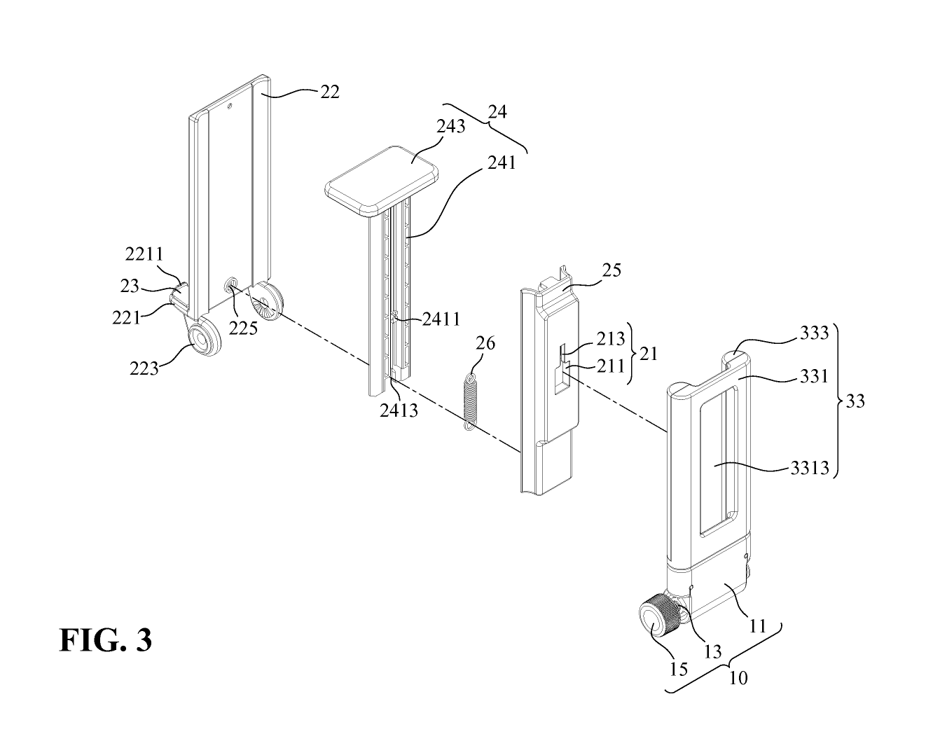

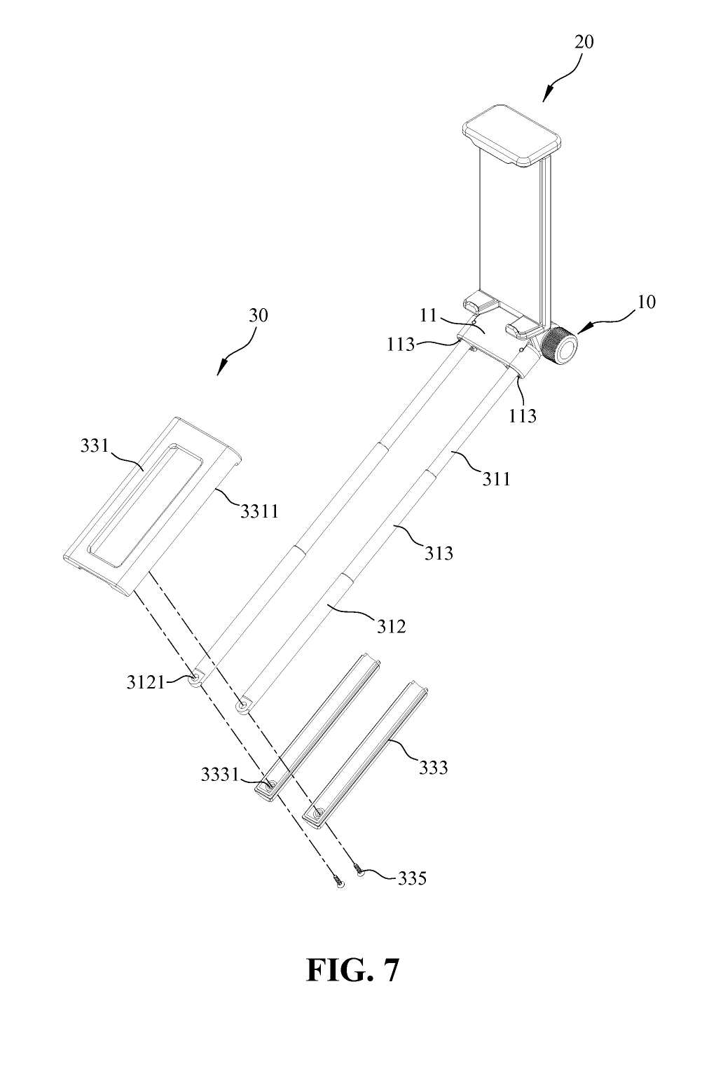

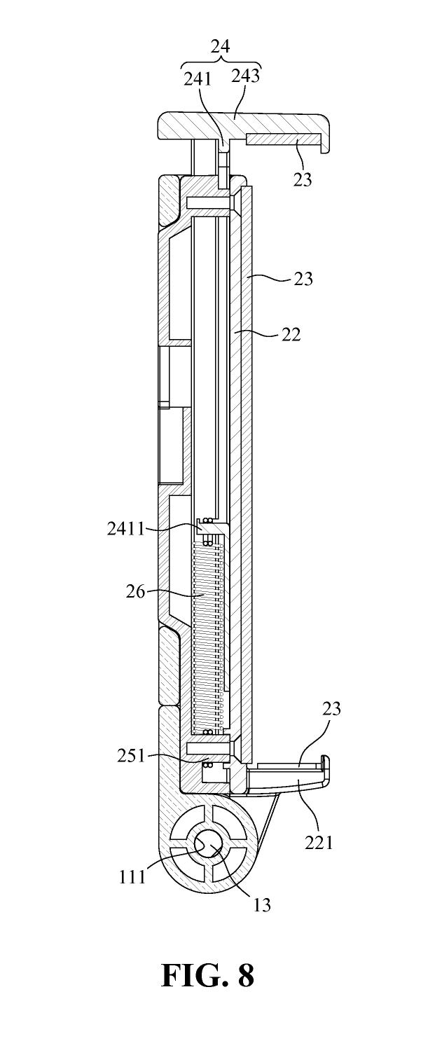

Referring to FIGS. 1-3, and FIGS. 7 and 8, wherein FIG. 1 is a perspective view of a clamping device with auxiliary functions according to the present invention; FIG. 2 is an exploded view of the clamping device with auxiliary functions according to the present invention; FIG. 3 is an exploded view of the clamping device with auxiliary functions according to the present invention from another angle; FIG. 7 is a partial exploded view of the clamping device with auxiliary functions according to the present invention; and FIG. 8 is a cross-sectional and lateral side view of the clamping device of the present invention taken along lines A-A in FIG. 1. As illustrated, the clamping device of the present invention includes a pivot seat 10, a clamp seat 20 and a telescopic structure 30.

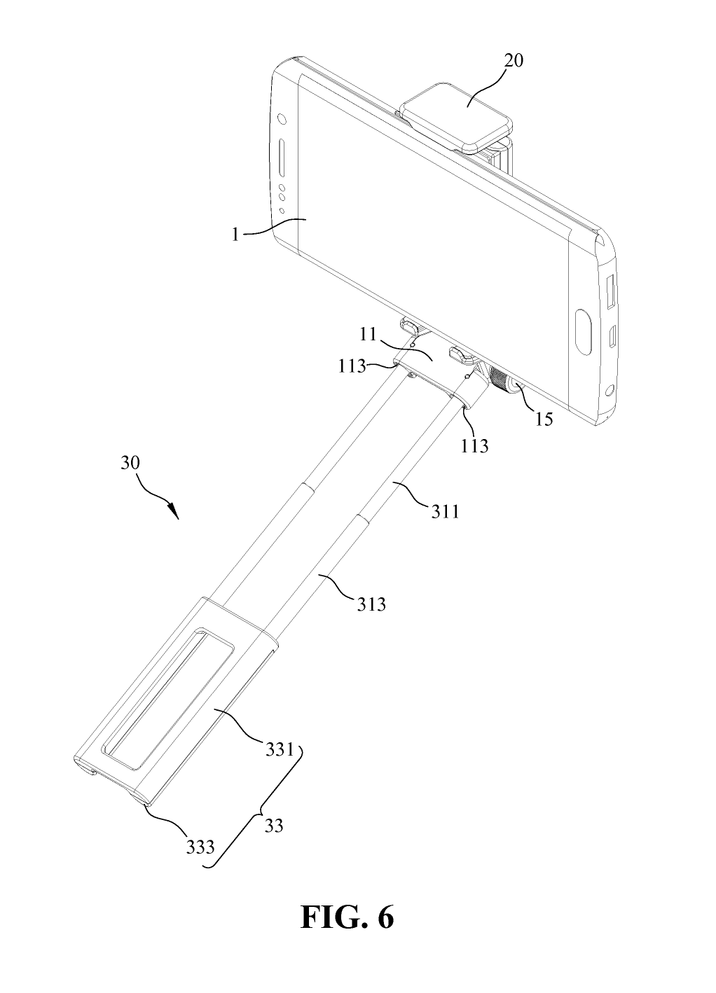

The pivot seat 10 includes a pivot body 11, an axle 13 and a rotary knob 15. The pivot body 11 defines a horizontal through hole 111 (see FIG. 8) extending through two opposite ends of the pivot body 11 and close to a bottom of the pivot body 11, and two vertical holes 113 (see FIGS. 6 and 7) at two opposite ends of the pivot body 11 and close to a top of the pivot body 11 and perpendicular to the horizontal through holes 111. One end of each vertical hole 113 is formed with an opening and the other end of each vertical hole 113 is close. The axle 13 extends rotatably through the horizontal through hole 111 in the pivot body 11 while the rotary knob 15 is mounted detachably on one end of the axle 13.

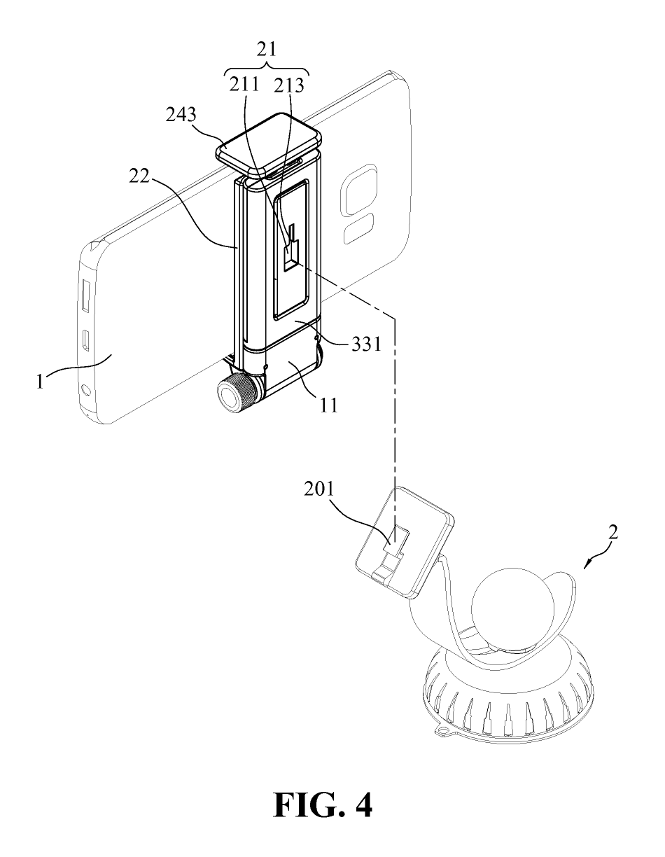

The clamp seat 20 is used for clamping an object (such as a smart phone or a tablet computer) thereon and is formed a hook member 21, and has a lower portion connected pivotally to the pivot seat 10. To be more specific, the clamp seat 20 is rotatable relative to the pivot seat 10 in a range greater than 180°. Note that that rotation range is set as an example only, other smaller or greater range should also be included in the scope of the present invention. The clamp seat 20 preferably includes a primary plate 22, a clamping block 24, a back plate 25 and a spring 26. The primary plate 22 has a front side surface formed with two support stubs 221 projecting frontward and a rear side surface formed with the lower portion and two pivot lugs 223 projecting rearward for connecting pivotally to the pivot seat 10, into which the axle 13 is inserted rotatably. The clamping block 24 includes a movable plate 241 disposed movably between the primary plate 22 and the back plate 25, and a clamping plate 243 disposed atop the movable plate 241 in such a manner to extend transversely, frontwardly beyond a top end of the primary plate 22. The clamp seat 20 further includes four cushioning pads 23, one is disposed on the front side surface of the primary plate 22, two on the support stubs 221 of the primary plate 22 while one is disposed at a lower surface the clamping plate 243 in front of the movable plate 241. The back plate 25 has a rear side surface formed with the hook member 21. Preferably, the hook member 21 is configured as an engagement channel that consists of a dented portion 211 and an opening portion 213 connected spatially with the dented portion 211 and extending through the back plate 25. The opening portion 213 has a dimension smaller than the dented portion 211 such that the dented portion 211 and the opening portion 213 are configured as inverted T-shaped (see FIG. 4). The spring 26 is disposed between the movable plate 241 and the back plate 25, and has two opposite ends respectively connected to the movable plate 241 and the back plate 25. To be more specific, the rear side surface of the primary plate 22 is formed with an insert hole 225. The back plate 25 has a front side surface formed with an insert stick 251 for extending into the insert hole 225 in the primary plate 22. The movable plate 241 has a rear side surface formed with a hook 2411 for engagement with one end of the spring 26 while another end thereof is engaged to the insert stick 251 of the back plate 25. In this embodiment, the movable plate 241 has a lower portion formed with an opening 2413 to permit extension of the insert stick 251 of the back plate 25 while the movable plate 241 is disposed movably between the primary plate 22 and the back plate 25.

The telescopic structure 30 is disposed behind the clamp seat 20, defines a hollow space 3313 corresponding to the hook member 21 of the back plate 25, and includes two retractable rod units 31. Each retractable rod unit 31 includes a first retractable rod 311 having a first end connected to the pivot seat 10 and a second retractable rod 312 connected movably to the first retractable rod 311 such that the second retractable rods 311 are movable relative to the first retractable rods 312 between a retractable position, in which, the first retractable rods 311 are accommodated within the second retractable rods 312 and an extended position, in which, the first retractable rods 311 are exposed at least partially to an exterior of the second retractable rods 312. To be more specific, each of the two second retractable rods 312 defines a first-rod reception channel such that when the second retractable rods 312 are moved to the retractable position, the first retractable rods 311 are accommodated within the first-rod reception channels in the second retractable rods 312 and that when the second retractable rods 312 are moved to the extended position, the first retractable rods 311 are exposed at least partially to the exteriors of the second retractable rods 312. Preferably, each retractable rod unit 31 further includes a third retractable rods 313 connected telescopically to the first and second retractable rods 311, 312. Each of the two third retractable rods 313 defines a second-rod reception channel such that when the second and third retractable rods 311, 313 are moved to the retractable position, the first retractable rods 311 are accommodated within the second-rod reception channels in the third retractable rods 313 while the third retractable rods 313 are accommodated with the first-rod reception channels in the second retractable rods 312 and when the second and third retractable rods 311, 313 are moved to the extended position, the first retractable rods 311 are exposed at least partially to the exteriors of the third retractable rods 313 while the third retractable rods 313 are exposed at least partially to the exteriors of the second retractable rods 312 (see FIG. 7). In this embodiment, the telescopic structure 30 further includes a handgrip 33 defining two parted rod-reception channels 3311 for receiving the two second retractable rods 312 therein. The handgrip 33 includes a handgrip body 331 formed with the two parted rod-reception channels 3311 and the hollow space 3313, two covers 333 respectively covering the two parted rod-reception channels 3311 and formed with two positioning holes 3331, and two fasteners 335 in the form of screws extending through two positioning holes 3121 in the two second retractable rods 312 and the two positioning holes 3331 in the two covers 333, thereby fixing the two second retractable rods 312 in the two parted rod-reception channels 3311. It is to note that the first ends of the first retractable rods 311 extend respectively into the two vertical holes 113 in the pivot body 11, thereby fixing the first retractable rods 311 in the pivot body 11 so that when the lower portion of the primary plate 22 is connected pivotally to the axle 13, rotation of the rotary knob 15 relative to the pivot body 11 results in tightening and loosening of the lower portion of the primary plate 22 relative to the pivot body 11.

After explaining the connection arrangement among the elements, a first used mode of the clamping device of the present invention will be described herein. As best illustrated in FIGS. 4 and 8, the clamping device of the present invention is shown in a use condition together with a suction device 2, wherein the clamping plate 243 is manually raised upward slightly against the tension force of the spring 26 relative to the two support stubs 221 in order to permit clamping of a smart phone 1 on the primary plate 22 by virtue of the three cushion pads 23. Since the hook member 21 consisting of the dented portion 211 and the opening portion 213 is exposed via the hollow space 3313 in the handgrip body 331, the assembly consisting of the pivot seat 10 and the clamp seat 20 is brought toward the suction device 2, thereby allowing extension of a hanger 201 of the suction device 2 into the dented portion 211 and the opening portion 213. Once the suction cup of the suction device 2 is press-fitted on the windscreen of a vehicle (not visible) and when the smart phone 1 is switched to a navigation mode, route maps or navigation information will be displayed over the display panel of the smart phone 1.

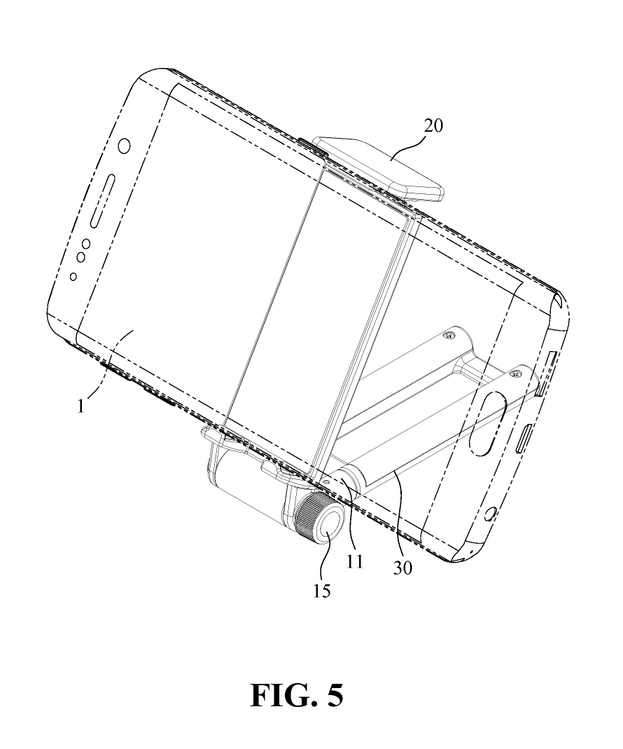

FIG. 5 shows a second used mode of the clamping device of the present invention. Since mounting of the smart phone 1 on the clamp seat 20 is same as previously described, the same is omitted herein for the sake of brevity. When the telescopic structure 30 of the clamping device of the present invention is placed over a flat support surface, rotation of the rotary knob 15 relative to the pivot body 11 results in causing turning of the primary plate 22 relative to the pivot body 11. In the event, the primary plate 22 (the clamp seat 20) is adjusted to a desired angle after tightening the rotary knob 15 relative to the pivot body 11, the user can read the text or surf the Internet over the smart phone 1.

FIG. 6 shows the clamping device of the present invention is in use in a third mode, i.e., the clamping device serves as a phone photo-taking selfie stick. After mounting the smart phone 1 on the clamp seat 20 and the primary plate 22 (the clamp seat 20) by virtue of the four cushion pads 23 and is adjusted to a desired angle after tightening the rotary knob 15 relative to the pivot body 11, and whenever the user wishes to take a photo of oneself, all he needs to do is pulling all the retractable rods 311, 312, 313 to an extended position by one hand while the other hand gripping the handgrip body 331, thereby placing the smart phone 1 at a desired height or angle with respect to the user. The photo-taking action is performed at preset interval.

The telescopic structure 30 of the clamping device of the present invention not only provides the extendable-retractable function, the support functions but also does not hinder mounting of the hanger 201 of the suction device 2 to the back plate 25 of the clamping device of the present invention, thereby providing several auxiliary functions to the user.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A clamping device comprising:
a pivot seat;
a clamp seat for clamping an object thereon and formed a hook member, and having a lower portion connected pivotally to said pivot seat; and
a telescopic structure disposed behind said clamp seat, defining a hollow space corresponding to said hook member of said clamp seat, and including two retractable rod units, each retractable rod unit including a first retractable rod having a first end connected pivotally to said pivot seat and a second retractable rod connected movably to said first retractable rod such that said second retractable rod is movable relative to said first retractable rod between a retractable position, in which, said first retractable rod is accommodated within said second retractable rod and an extended position, in which, said first retractable rod is exposed at least partially to an exterior of said second retractable rod.

2. The clamping device according to claim 1, wherein said clamp seat includes a primary plate, a clamping block, a back plate and a spring, said primary plate having a front side surface formed with two support stubs projecting frontward and a rear side surface formed with said lower portion and two pivot lugs projecting rearward for connecting pivotally to said pivot seat, said clamping block including a movable plate disposed movably between said primary plate and said back plate and a clamping plate disposed atop said movable plate in such a manner to extend transversely, frontwardly beyond a top end of said primary plate, said back plate having a rear side surface formed with said hook member, said spring being disposed between said movable plate and said back plate and having two opposite ends respectively connected to said movable plate and said back plate.

3. The clamping device according to claim 2, wherein said rear side surface of said primary plate is formed with an insert hole, said back plate having a front side surface formed with an insert stick for extending into said insert hole in said primary plate, said movable plate having a rear side surface formed with a hook for engagement with one end of said spring while another end thereof is engaged to said insert stick of said back plate.

4. The clamping device according to claim 3, wherein said movable plate has a lower portion formed with an opening to permit extension of said insert stick of said back plate while said movable plate is disposed movably between said primary plate and said back plate.

5. The clamping device according to claim 2, wherein said clamp seat includes four cushioning pads, one disposed on said front side surface of said primary plate, two on said support stubs of said primary plate while one is disposed at a lower surface of said clamping plate in front of the movable plate.

6. The clamping device according to claim 1, wherein said hook member is configured as an engagement channel.

7. The clamping device according to claim 6, wherein said engagement channel consists of a dented portion and an opening portion connected spatially with said dented portion and extending through said back plate and having a dimension smaller than said dented portion.

8. The clamping device according to claim 7, wherein said dented portion and said opening portion of said engagement channel are configured as T-shaped.

9. The clamping device according to claim 1, wherein each of said two second retractable rods defines a first-rod reception channel such that when said second retractable rods are moved to said retractable position, said first retractable rods are accommodated within said first-rod reception channels in said second retractable rods and that when said second retractable rods are moved to said extended position, said first retractable rods are exposed at least partially to said exteriors of said second retractable rods.

10. The clamping device according to claim 9, wherein each retractable rod unit further includes a third retractable rods connected telescopically to said first and second retractable rods.

11. The clamping device according to claim 10, wherein each of said two third retractable rods defines a second-rod reception channel such that when said second and third retractable rods are moved to said retractable position, said first retractable rods are accommodated within said second-rod reception channels in said third retractable rods while said third retractable rods are accommodated with said first-rod reception channels in said second retractable rods, and when said second and third retractable rods are moved to said extended position, said first retractable rods are exposed at least partially to said exteriors of said third retractable rods while said third retractable rods are exposed at least partially to said exteriors of said second retractable rods.

12. The clamping device according to claim 1, wherein said telescopic structure further includes a handgrip defining two parted rod-reception channels for receiving said two second retractable rods therein.

13. The clamping device according to claim 12, wherein said handgrip includes a handgrip body formed with said two parted rod-reception channels and said hollow space, two covers respectively covering said two parted rod-reception channels and formed with two positioning holes, and two fasteners extending through two positioning holes in said two second retractable rods and said two positioning holes in said two covers, thereby fixing said two second retractable rods in said two parted rod-reception channels.

14. The clamping device according to claim 1, wherein said pivot seat includes a pivot body defining a horizontal through hole and two vertical holes for receiving said two first retractable rods therein, an axle extending rotatably through said horizontal through hole in said pivot body, and a rotary knob mounted detachably on one end of said axle, said lower portion of said clamp seat being connected pivotally to said axle such that rotation of said rotary knob relative to said pivot body results in tightening and loosening of said lower portion of said clamp seat relative to said pivot body.

15. The clamping device according to claim 1, wherein said clamp seat is rotatable relative to said pivot seat greater than 180°.
